(19) United States
(12) Patent Application Publication
(10) Pub. No.: US 2012/0182207 A1
(43) Pub. Date: Jul. 19, 2012

(54) HIGH RESOLUTION SCINTILLATING DISPLAY AND METHOD OF USE

(76) Inventors: Samuel Mark Cowan, Rock Springs, WY (US); Roman Zenon Shwed, Coconut Creek, FL (US); Lindsay Cowan, Rock Springs, WY (US)

(21) Appl. No.: 13/032,767

(22) Filed: Feb. 23, 2011

Related U.S. Application Data
(60) Provisional application No. 61/433,745, filed on Jan. 18, 2011.

(51) Int. Cl. G09G 3/20

(52) U.S. Cl. 345/55

(57) ABSTRACT

The present invention relates generally to a high resolution scintillating display. More specifically, this disclosure relates to a display comprised of a support frame matrix configured to secure a plurality of free moving display elements. Each display element is precisely positioned on the supporting frame matrix and having one or more image elements of the overall display printed thereon. The desired high resolution image is created after each individual display element is in place.

The present application results from and claims priority to, Provisional Application No. 61/433,745, HIGH RESOLUTION SCINTILLATING DISPLAY AND METHOD OF USE, Filed Jan. 18, 2011. Additionally, the present application is related to Non-Provisional application Ser. No. 12/784,354, REFLECTIVE DECORATIVE ASSEMBLY, Filed May 20, 2010; the complete disclosure of the aforementioned application is incorporated by reference.

### BACKGROUND OF THE INVENTION

The present invention relates generally to a high resolution scintillating display. More specifically, this disclosure relates to a display comprised of a support frame matrix configured to secure a plurality of free moving display elements, each display element is precisely positioned on the supporting frame matrix and having a portion of the overall display printed thereon.

Displays having a fluid surface composed of multiple display elements include, displays composed of sheet material and displays composed of a plurality of disks. The sheet material displays include a plurality of elongate resilient sheets having one elongate edge cut into ribbons or fringe. The resilient sheets are attached in an overlapping fashion, allowing the fringe to move freely when subjected to a wind or breeze. This method is used primary as a design element for a display, providing a fluid surface and typically an element of flash. However, due to the large size of homogenous color or material and the linear configuration of the resilient sheets, this method is not conductive for creating any significant detail, such as a graphic, picture or words on the display. Displays using a plurality of disks, attached to posts or pegs, are commonly known in the art of displays. Devices such as, a Scintillating Decorative Display Device, U.S. Pat. No. 4,308,680, Brak Bnei or Decorative Sheet, U.S. Pat. No. 4,017,992, Akira Kajitani are both examples of disk display devices. For each aforementioned disk display device, the individual disks are attached in such manner as to allow the disks to move in the wind or breeze, which again, creates a fluid surface that attracts the viewer through movement and reflected light. The disk type display allows the user to create images and message content in greater detail than the fringed sheet material display. The resolution of the overall display is limited by, the size of the display and the size of the individual display disks. A relatively detailed display could be created by using a large overall display board with relatively small display disks. However, as a practical limitation, sequentially placing and securing thousands of individual display disks on a large billboard would be labor intensive and cost prohibitive.

What is needed is a practical solution to the diminished resolution of disk type displays and a method of sequentially placing the myriad of disks without excessive costs or labor.

### SUMMARY OF THE INVENTION

A first embodiment of the present invention includes, a resilient light weight support frame having a planer grid back portion and a plurality of posts extending perpendicular to the back portion. The support frame configured to work in conjunction with additional support frames and may be used to cover most surfaces where a display is desired. The support frame post cross-section may be any shape, but for most practical applications the cross-section is circular. The terminating end of the post having a smaller diameter than the base end creating a shoulder in the mid-section of the post. Display elements having an attachment hole of a diameter larger than the post end, but smaller than the base end. When a display element is placed on a post, the display element is supported on the post shoulder, positioning the display element away from the back portion of the support frame, allowing the element to move freely on the post. The display elements are fixedly attached to the plurality of posts by using heat to deform the post end. The display elements can be formed from any resilient material and may be configured as a circle, oval, diamond, octagon, square or a custom shape such as a trademark shape as desired by the user. The display elements may have a high gloss finish or a matte finish, may be a reflective or holographic material, may be a solid color, have multiple colors or patterns or may have a portion of a larger display image printed thereon. It is understood the display image may be printed on only of the front surface of the display elements, or it may be printed on both the front and rear surfaces of the display elements.

In one embodiment of the present invention, the display elements are pre-cut and individually installed on the support frame posts.

In another embodiment, an elongated sheet of resilient material is partially cut or scored to include a plurality of display elements. The mounting holes for the plurality of display elements positioned to correspond with the support frame posts. The user can place the entire sheet of display elements on the support frame posts, deform the post heads using heat and then remove the excess material from the attached display elements.

In yet another embodiment of the present invention, a user may determine a complex image to be created using display elements. The image is prepared using suitable graphics or printing software; this may include dividing the image into a series of narrow sections that correspond with the image to be displayed. It is noted that the series of narrow sections may run either vertically or horizontally depending upon the major axis of the display and considering whether the support frame matrix will be filled when the display is flat or in a upright or vertical position. The display image is printed onto the narrow sections of resilient material using a carriage printer; the image may be printed on the front surface or on both, front and back surfaces. The resilient material is commercially available and is typically on rolls of several thousand feet and 1 foot wide. When a section is printed, a reference number for the location of the image is written on the printed section and then cut to length. The sections will then be mechanically cut or scored to provide a plurality of display elements. A technician will use the reference numbers to place the printed sections on the support frames. The mounting hole for each display element will be pressed onto an underlying support frame post and the terminal end will be deformed using heat to securely attach the display element. The excess resilient material is then pulled away. The resulting display has the fluid characteristics of a scintillating sign with the high resolution of printed matter. The display will have some negative space depending upon the shape of the display elements and spacing between elements. It is understood that a square or rectangular element will have the least negative space between display elements however, it is considered desirable to have enough relief between elements to allow the display elements to move freely and provide the maximum scintillating effect. The overall resolution of the display image is only limited by the resolution of the printed image.

These and other features and advantages of the disclosure will be set forth and will become snore fully apparent in the detailed description that follows and in the appended claims. The features and advantages may be realized and obtained by the instruments and combinations particularly pointed out in the appended claims. Furthermore, the features and advantages of the disclosure may be learned by the practice of the methods or will be obvious from the description, as set forth hereinafter.

### BRIEF DESCRIPTION OF DRAWINGS

The following description of the embodiments can be understood in light of the Figures, which illustrate specific aspects of the embodiments and are part of the specification. Together with the following description, the Figures demonstrate and explain the principles of the embodiments. In the Figures the physical dimensions of the embodiment may be exaggerated for clarity. The same reference numerals in different drawings represent the same element, and thus their descriptions may be omitted.

FIG. 1 illustrates a support panel in accordance with one embodiment of the disclosure;

FIGS. 2A-2D illustrate embodiments of display elements of the present invention;

FIG. 3 illustrates a scintillating disk display from the prior art;

FIG. 4 illustrates a scintillating disk display of the present invention;

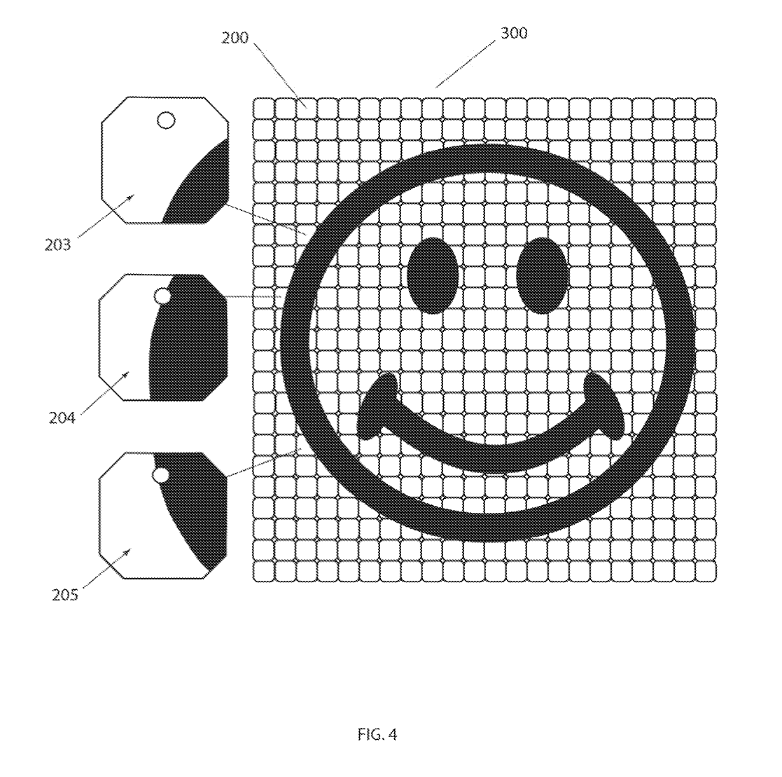

FIG. 5 illustrates a section of scored resilient material of the present invention;

FIG. 6 illustrates scored sheets of resilient material configured to create a display image, and;

FIG. 7 illustrates the progress of creating a high resolution scintillating display in accordance with one embodiment of the present disclosure.

### DETAILED DESCRIPTION OF THE INVENTION

For the purposes of promoting an understanding of the principles in accordance with the disclosure, reference will be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

As used in this specification and the appended claims, the singular forms “a,” “an,” and “the” include plural referents unless the context clearly dictates otherwise. In describing and claiming the present disclosure, the following terminology will be used in accordance with definitions set out below. As used herein, the terms “comprising,” “including,” “containing,” “characterized by,” and the grammatical equivalents thereof are inclusive or open-ended terms that do not exclude additional, unrecited elements or method processes.

The disclosure relates to a high resolution scintillating display. More specifically, this disclosure relates to a display comprised of a support frame matrix configured to secure a plurality of free moving display elements, each display element is precisely positioned on the supporting frame matrix and having a portion of the overall display printed thereon.

High resolution as currently understood in the art but not limited to current printing technology.

Scintillating display or a display having a moving fluid surface. The movement creates reflected light and shadow depending upon the current disposition of the individual display elements.

Support frame matrix or combination of a plurality of individual support frames.

Display elements are individual display disks.

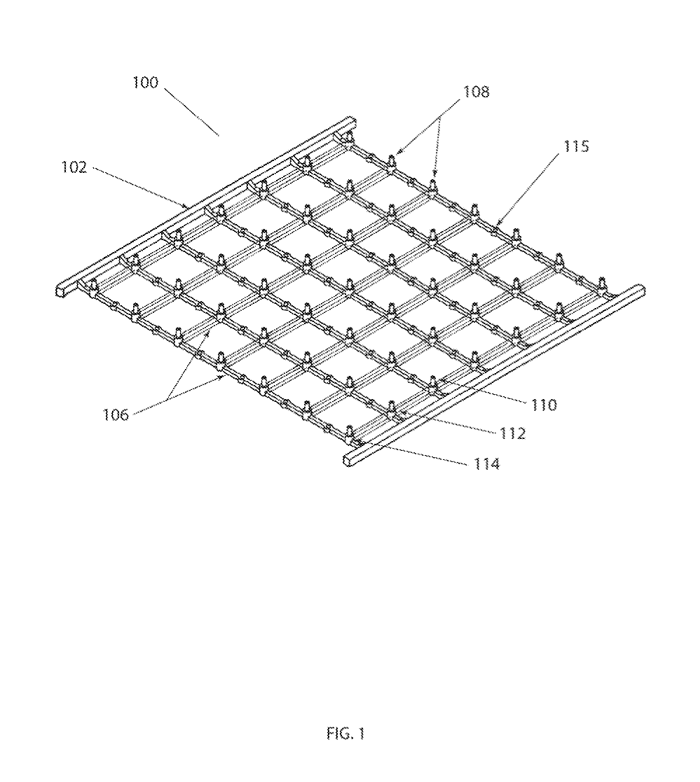

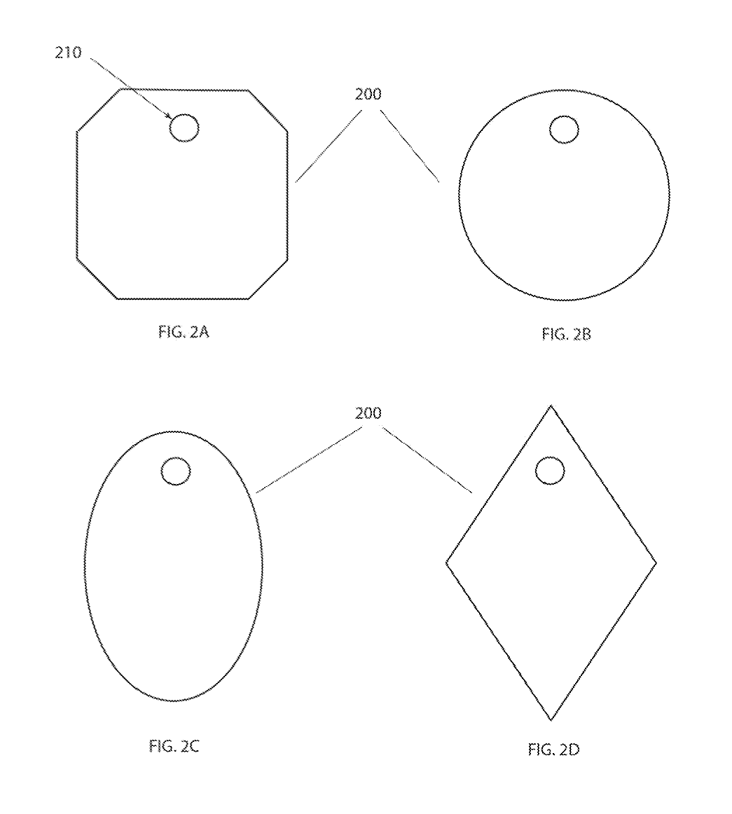

Illustrated in FIG. 1, support frame 100 includes, rigid side rails 102 and support rails 106 interlaced between the side rails 102, forming a light weight, substantially planer back portion or platform. Support frame posts 108 are perpendicular with, and extend away from, support rails 106. The support frame posts 108 having a base end 114, a head 110 or terminating end, and a display element support shoulder 112. Support rails 106 include a plurality of mounting holes 115. Support frame 100 can be mounted individually or as matrix of multiple support frames 100, depending upon the dimensions of the final display. The support frame 100 may be attached to the ornamented surface using screws or nails inserted through mounting hole 115 or may be attached with staples, adhesive, zip ties, wire ties, clips or a releasable hook and loop fasteners. Illustrated in FIGS. 2A, 2B, 2C and 2D are embodiments of display elements 200 of the present invention. The display elements 200 may be one of substantially square, rectangular, round, oval, triangular, diamond, octagon or any other geometric shape or custom shape desired by the user. The display element 200 are attached to support frame 100 by placing mounting hole 210 over the head 1.10 of the support frame post 108 and the head 110 is deformed using a heat source to form a ball or cap. The display element 200 will rest on support shoulder 112 and is moveably retained by deformed head 110.

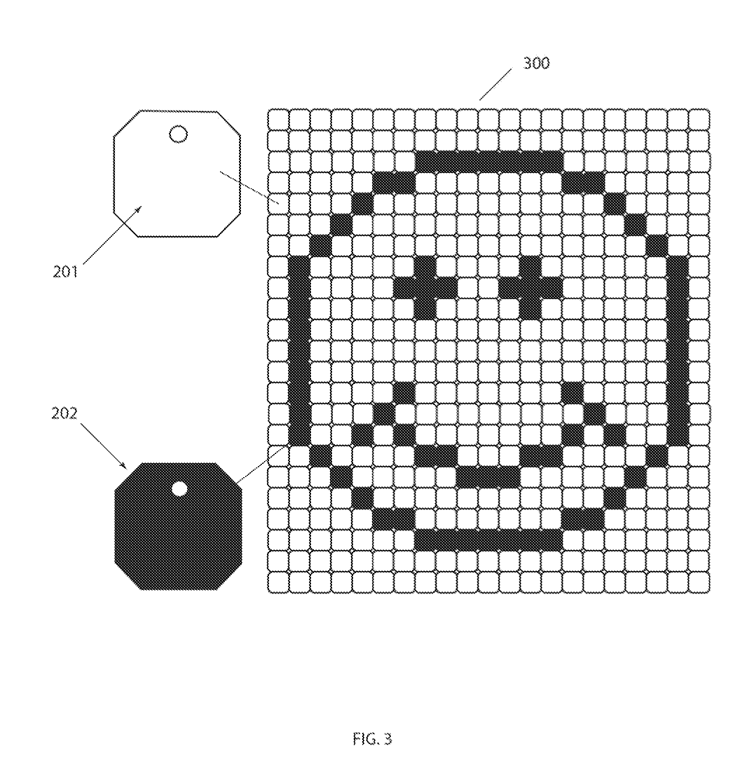

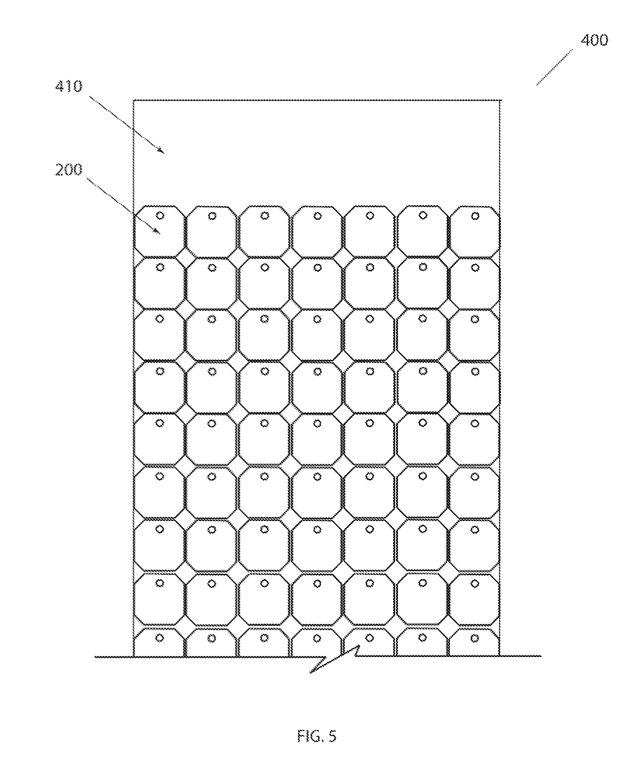

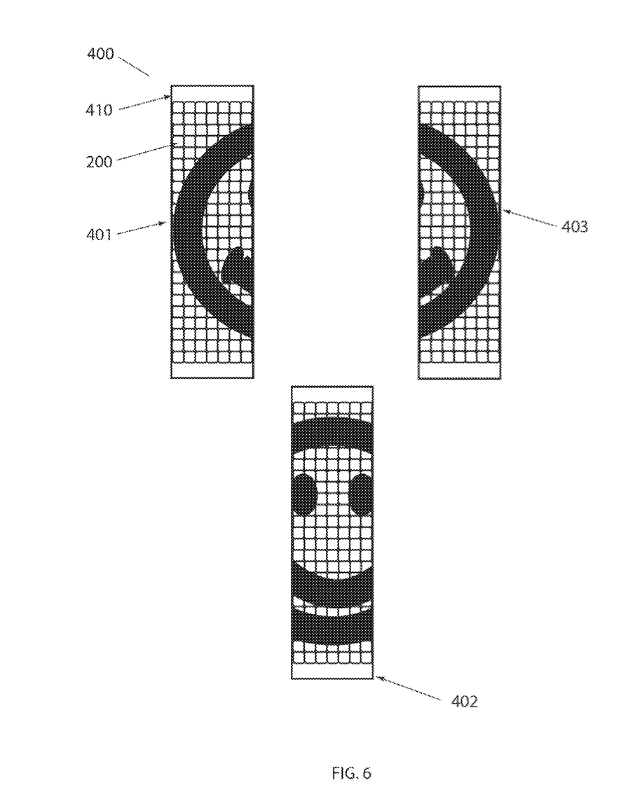

FIG. 3 illustrates a prior art disk type display 300 having single color display elements 201 and 202. As shown, the resolution of display 300 is limited by the size and number of display elements 201 and 202. Simple horizontal or vertical lines may be readily created but, this format is not conducive for representing the curved lines of a simple image. Whereas, in accordance with one embodiment of the present invention an accurate representation of an image may be created on a disk type display 300, where some of the display elements 200 include a preprinted portion of the overall image. As shown, each of display elements 203, 204 and 205 contain a portion of the overall image. For one embodiment of the present invention each display element 200 must be preprinted, sequentially arranged, and individually placed in order to form the desired image. Illustrated in FIG. 5 is one embodiment of the present invention, where display elements 200 are partially cut or scored into an elongate sheet of resilient stock material 400. The first end 410 of stock material 400 can be feed through a printer to create a high definition image on the stock material 400 prior to cutting and scoring. As shown in FIG. 6, each of stock material sections 401, 402 and 403 contain a portion of the overall image. The stock material sections 401, 402 and 403 can be placed on a support frame matrix 100 and attached to posts 108 by placing the mounting holes 210 of each display element 200 over the support frame posts 108 and deforming post heads 110. The excess material from stock Material sections 401, 402 and 403 is then removed, forming the complete image with display elements 200 that can freely move on support frame posts 108.

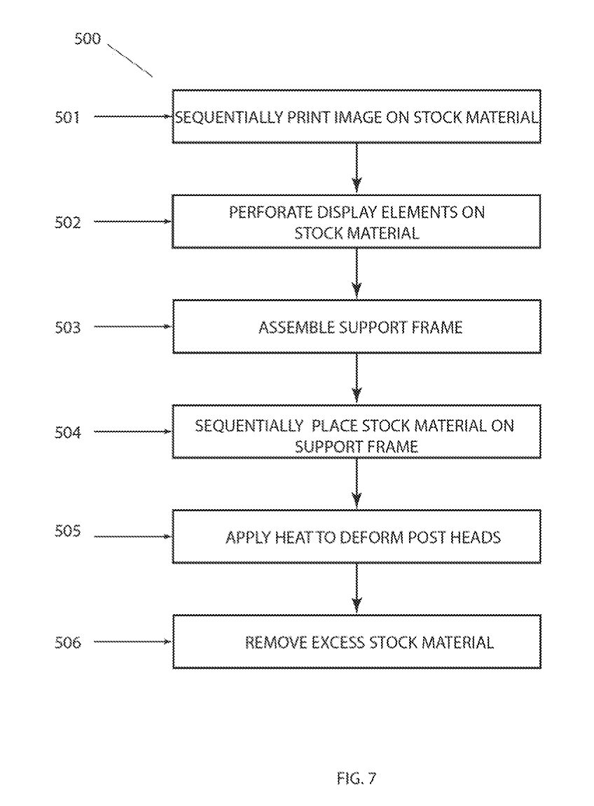

FIG. 7 illustrate the procedural steps 500 used to create a scintillating display in accordance with one embodiment of the present invention. Once an image is selected it must be electronically manipulated to created a sequential pattern of narrow images, the narrow images are printed onto a resilient stock material 501 and marked to indicate the sequence for installation. Once printed, the resilient stock material can be partially cut or scored in order to form individual display elements with mounting holes 502. A support frame matrix of proper size is assembled using a plurality of support frames 503. The printed stock material is sequentially placed on the support frame matrix with support frame posts extending through the display element mounting holes 504, heat is then applied to deform the support frame post heads and permanently attach the individual display elements 505. Once the display elements are attached the excess stock material is removed 506, completing the display and allowing the individual display elements to move freely.

It is to be understood that the above mentioned arrangements are only illustrative of the application of the principles of the present disclosure. Numerous modifications or alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A high resolution scintillating display comprising:
a frame matrix having a plurality of support posts;
a display image having a plurality of visual elements, and;
a plurality of display elements, each display element including; a mounting hole, a front surface, a rear surface, one or more of the plurality of visual elements printed on the front surface, and a specific display location.

2. The high resolution scintillating display of claim 1, wherein; the plurality of visual elements is printed on both the front surface and the rear surface of the plurality of display elements.

3. The high resolution scintillating display of claim 1 wherein; the plurality of display elements are one of a circle, oval, square, rectangle, hexagon, pentagon, octagon and a custom shape.

4. The high resolution scintillating display of claim 1 wherein; the plurality of display elements is configured as a plurality of perforated sheets including, a front surface, a rear surface, the plurality of display elements and a removable waste portion.

5. The high resolution scintillating display of claim 4 wherein; the display image having a plurality of visual elements printed on the front surface of plurality of perforated sheets, each display element having one or more of the plurality of visual elements printed thereon.

6. The high resolution scintillating display of claim 4 wherein; the display image having a plurality of visual elements printed on the front surface and the rear surface of plurality of perforated sheets, each display element having one or more of the plurality of visual elements printed thereon.

7. The high resolution scintillating display of claim 1 wherein; one of the plurality of display elements is specifically positioned on one of the plurality of support posts.

8. The high resolution scintillating display of claim 4 wherein; one of the plurality of perforated sheets is specifically positioned on one or more of the plurality of support posts.

9. A method of creating a high definition scintillating display comprising:
providing a frame matrix, including; a plurality of support posts, each of the plurality of support posts including; a base end, a terminal end, and a support shoulder; the terminal end having a first diameter, the support shoulder having a second diameter;
providing a display image having a plurality of visual elements, and;
providing a plurality of display elements, each of the display elements including; a mounting hole, having a diameter larger than the diameter of the terminal end of the support posts and the diameter smaller than the diameter of the support shoulder of the support posts, a front surface, a rear surface, one or more of the plurality of visual elements printed on at least the front surface, and a specific display location.

10. The method of claim 9 including, installing each of the plurality of display elements in the specific display location.

11. The method of claim 10 wherein, installing comprises: inserting the terminal end of one of the plurality of support posts through the mounting hole of one of the plurality of display elements, a portion of the back surface of the display element resting on the support shoulder of the mounting post, and;
deforming the terminal end of the support post using heat, such that at least one dimension of the deformed end is larger than diameter of the mounting hole of the display element.

12. A method of creating a high definition scintillating display comprising:
providing a frame matrix, including; a plurality of support posts, each of the plurality of support posts including; a base end, a terminal end, and a support shoulder; the terminal end having a first diameter, the support shoulder having a second diameter;
providing a display image having a plurality of visual elements, and;
providing a plurality of display elements configured as a plurality of perforated sheets, the plurality of perforated sheets including; a front surface, a rear surface, a specific display location, the plurality of display elements and a removable waste portion; each display element including; a mounting hole, having a diameter larger than the diameter of the terminal end of the support posts and the diameter smaller than the diameter of the support shoulder of the support posts, a front surface, a rear surface, and one or more of the plurality of visual elements printed on at least the front surface.

13. The method of claim 12 including, installing one of the plurality of perforated sheets in the specific display location on one or more of the plurality of support posts.

14. The method of claim 13 wherein, installing comprises: inserting the terminal end of one of the plurality of support posts through each of mounting holes of the plurality of display elements, a portion of the back surface of each of the plurality of display elements resting on the support shoulder of one of the plurality of mounting posts, and;
deforming the terminal ends of the plurality of support posts using heat, such that at least one dimension of the deformed ends is larger than diameter of the mounting hole of the display element.

15. The method of claim 12 including, removing the waste portion.
